(19) United States
(12) Patent Application Publication
(10) Pub. No.: US 2002/0009185 A1
(43) Pub. Date: Jan. 24, 2002

(54) Method and device for security control of network distant input using caller ID

(76) Inventor: Chung-Chih Tung, Taipei (TW)

Correspondence Address: BIRCH STEWART KOLASCH & BIRCH, PO BOX 747, FALLS CHURCH, VA, 22040-0747, US

(21) Appl. No.: 09/899,952

(22) Filed: Jul. 9, 2001

(30) Foreign Application Priority Data
Jul. 14, 2000 (TW) 89114055

(51) Int. Cl. H04M 1/56; H04M 13/00; H04M 1/66

(52) U.S. Cl. 379/142.01; 379/183; 379/184; 379/188; 379/200

(57) ABSTRACT

The specification discloses a method for security control of network distant input using caller ID, which uses an ID decoder to decode and extract a caller ID from an incoming message and determine whether the caller ID exists in its database before starting a password checking step. The invention also discloses the corresponding device.

### BACKGROUND OF THE INVENTION

1. Field of Invention

The invention relates to a method for security control of network distant input and the corresponding device and, in particular, to a method for security control of network distant input using caller ID and the corresponding device.

2. Related Art

Recently, network security techniques have become very important topics in the field of information technology. However, most current information security methods focus on enhancing the protection of firewalls. The firewall can protect against illegal invasion by anonymous persons. On the Internet, the function of the firewall is to prevent illegal users from entering the Intranet of an enterprise. It usually has the function of checking identities. Only verified persons are allowed to enter the Intranet system. At the same time, it also provides the host proxy services inside the enterprise, simplifying the channel from the enterprise Intranet to the Internet.

For example, in practice, enterprises using the UNIX system in their Intranet can use Windows NT as the software firewall or routers as the hardware filtering network packets. Usually, software firewalls can provide more complicated functions, whereas hardware firewalls have faster processing speeds.

Though firewall techniques are continuously evolving and improving , computer hackers always find some way to break into systems, committing many hacking related crimes. There is still not an effective solution to this problem . For example, an ex-employee of an IC design and manufacturing company can find a way to use the Internet to log into his former company's computer system, posing as the supervisor, and change the IC layouts. The company then uses incorrect IC layouts to manufacture its products, and loses money. Therefore, it is important to have a verification mechanism that can verify the true identity of any user.

### SUMMARY OF THE INVENTION

The invention provides a method for security control of network distant input using caller ID, which mainly uses an ID decoder to decode and extract the caller ID from an incoming message for the authentication of the caller before performing normal password checking. The purpose is to prevent computer hackers from breaking into the system through some channel or by cracking the password. Any registered user has to use an authorized phone line to connect to the network, achieving the goal of security control of network distant input.

### BRIEF DESCRIPTION OF THE DRAWINGS

The present invention will become more fully understood from the detailed description provided below. However, this description is for purposes of illustration only, and thus is not limitative of the present invention, wherein:

FIG. 1 shows a structure of conventional security control of network distant input;

FIG. 2 shows a structure of security control of network distant input using caller ID according to the invention;

FIG. 3 shows a flowchart of security control of network distant input using caller ID according to the invention; and

FIG. 4 is a flowchart of automatic connection monitoring according to the invention.

### DETAILED DESCRIPTION OF THE INVENTION

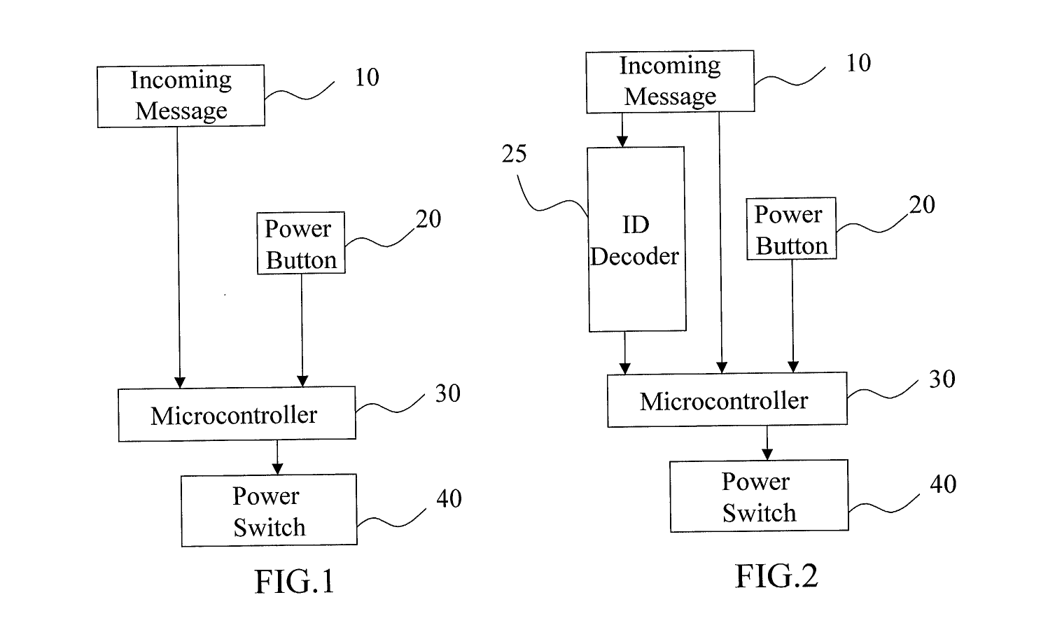

Enterprise network systems often have hosts for distant dialup. Through telephone line connections, data can be transmitted between personal users and the enterprise or between enterprises. As shown in FIG. 1, one party makes a phone call in order to send an incoming call message 10 to the computer host with which the party wishes to connect. Usually, the computer host has a power button 20 coupled to a microcontroller 30. The microcontroller 30 receives the incoming call message 10 and initiates a verification mechanism to verify the identity of the user. After verification, the user logs on and a power switch 40 is turned on.

However, conventional security control methods make use of user passwords. If any password is released or cracked, computer hackers can easily invade the computer system illegally. This makes effective security control impossible.

Therefore, the invention proposes a method for security control of network distant input using caller ID. It utilizes the caller's telephone ID for identity verification. Only authorized user phones are allowed to connect for users to continue on to conventional password verification. This method provides extra protection for the enterprise computer network system.

With reference to FIG. 2, one party makes a phone call in order to send an incoming call message 10 to the power on circuit of the computer to be connected with. Usually, the computer has a power button 20 coupled to a microcontroller 30. However, before the microcontroller 30 receives the incoming call message 10, an ID decoder 25 verifies whether the ID of the incoming call exists in a database. After the telephone ID is verified, the microcontroller 30 initiates a verification mechanism to verify the user's identity. Once the user is identified to be legitimate, he can then log into the system and turn on the power switch 40. Using the method disclosed herein, even if a computer hacker knows any password or is able to crack the password, he still cannot enter the system until he can access the phone line of any authorized user.

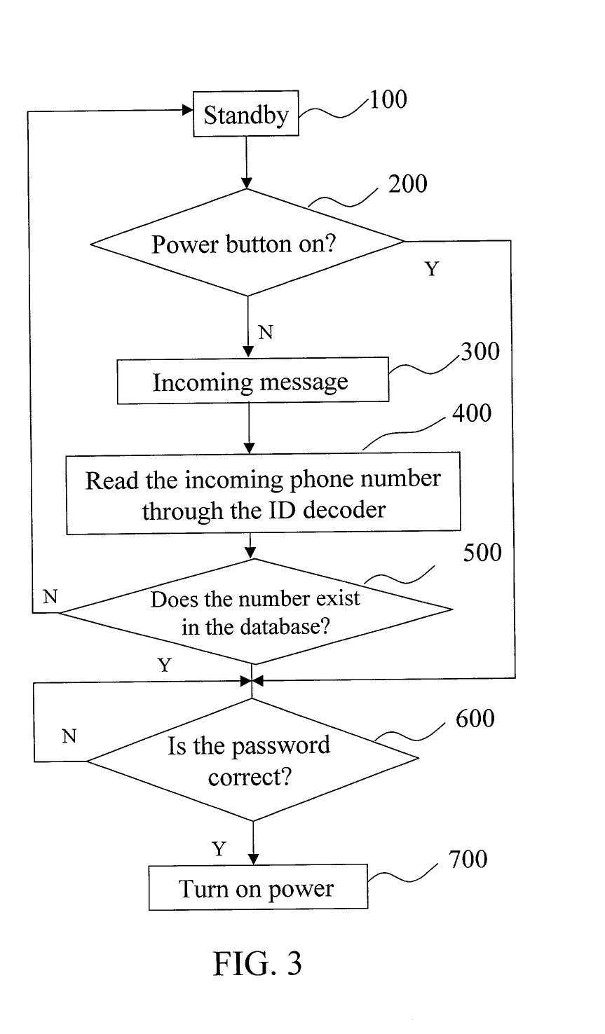

As shown in FIG. 3, the computer host is initially on standby (step 100) to wait for any incoming call message. The host system then determines whether the power button is on (step 200). If the power button is on, then the person who dials up can directly enter the password verification procedure to determine whether the password provided is correct (step 600). If the power button is not on, then the person dialing up sends out an incoming call message (step 300). The ID decoder then reads the incoming phone number (step 400). Once the caller's telephone ID is obtained, it is checked with the authorized ones stored in a database (step 500). If the database does not contain the caller ID, that means the person dialing up is not using an authorized phone number for connection, and he or she is not able to continue on to the password verification phase. The computer host automatically disconnects with the caller and returns to the standby state (step 100). If the caller ID exists in the database, then the user is calling from an authorized phone line and can continue on to the password verification phase to determine whether his password is correct. Once the user's identity is verified, the power is turned on (step 700).

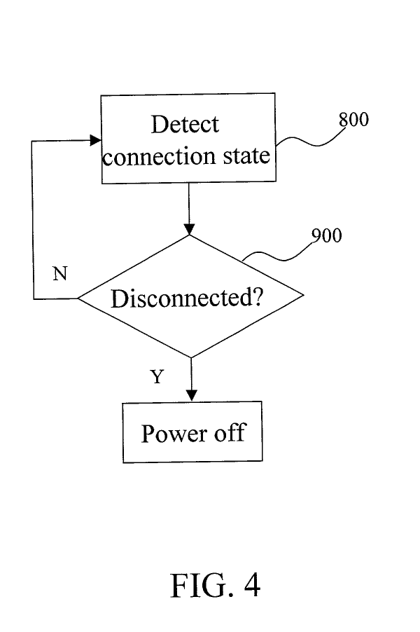

As shown in FIG. 4, after the user logs onto the computer host, an automatic monitoring program runs to monitor the connection status (step 800) and determine whether the connection is broken (step 900). As long as the user is not disconnected, the program continues monitoring. Otherwise, the computer host automatically shuts down.

Certain variations as would be apparent to those skilled in the art are to be considered within the spirit and scope of the claimed invention.

What is claimed is:

1. A method for security control of network distance input using caller ID, which comprises the steps of:
waiting an incoming call message;
extracting a caller ID from the incoming call message using an ID decoder;
verifying whether the caller ID exists in a database;
verifying the user's password; and
turning on a power switch for the user to use.

2. The method of claim 1 farther comprising the step of running a monitoring program to monitor the connection status after the step of turning on a power switch.

3. The method of claim 1, wherein the database contains authorized phone IDs.

4. A device for security control of network distance input using caller ID, which comprises:
an ID decoder to extract a caller ID from an incoming call message; and
a microcontroller to receive the caller ID, to verify whether the caller ID exists in
a database, and to turn on a power switch once the entered password is correct.

5. The device of claim 4, wherein a monitoring program runs to monitor the connection status after the power switch is turned on.

6. The device of claim 4, wherein the database contains authorized phone IDs.

7. The device of claim 4, wherein the work voltage of the microcontroller is controlled by a power button.
